(19) United States
(12) Patent Application Publication
(10) Pub. No.: US 2021/0293558 A1
(43) Pub. Date: Sep. 23, 2021

(54) CHARGING FACILITY GUIDANCE DEVICE, CHARGING FACILITY GUIDANCE METHOD, AND NON-TRANSITORY COMPUTER-READABLE MEDIUM STORING PROGRAM

(71) Applicant: HONDA MOTOR CO., LTD., Tokyo (JP)

(72) Inventor: Shigeru NAMIKI, Saitama (JP)

(21) Appl. No.: 17/198,210

(22) Filed: Mar. 10, 2021

(30) Foreign Application Priority Data
Mar. 17, 2020 (JP) 2020-045973

(51) Int. Cl. G01C 21/34; G06Q 10/02; G01C 21/36; B60L 53/66

(52) U.S. Cl. CPC G01C 21/3476; B60L 53/66; G01C 21/3691; G06Q 10/02

(57) ABSTRACT

A charging facility guidance device includes: a communication unit 110 that makes communication with a vehicle-installed communication device and with a charging facility C; and a calculation unit 130 that calculates a route for charging in which the charging facility C where an electric vehicle 200 is to be charged is incorporated between a predetermined start point and a predetermined destination, on the basis of vehicle notification information stored in a storage unit 160, received by the communication unit 110, and including identification information about the electric vehicle 200, positional information about the electric vehicle 200, information indicating a charging state of the electric vehicle 200, and round trip route information about a round trip between the predetermined start point and the predetermined destination, the round trip being made by the electric vehicle 200 equipped with the vehicle-installed communication device.

This application is based on and claims the benefit of priority from Japanese Patent Application 2020-045973, filed on 17 Mar. 2020, the content of which is incorporated herein by reference.

### BACKGROUND OF THE INVENTION

### Field of the Invention

The present invention relates to a charging facility guidance device, a charging facility guidance method, and a non-transitory computer-readable medium storing a program.

### Related Art

There have recently been known electric vehicles caused to travel by electric motors driven by electric power supplied from secondary cells (batteries). Such electric vehicles include battery electric vehicles (BEVs), hybrid electric vehicles (HEVs), plug-in hybrid electric vehicles (PHEVs), fuel cell vehicles (FCVs), and plug-in fuel cell vehicles (PFCVs).

A technique of determining an intended charging quantity on the basis a history of use of an electric vehicle or a battery residual charge quantity in the electric vehicle is known (see patent document 1, for example).
Patent Document 1: Japanese Unexamined Patent Application, Publication No. 2015-230719

### SUMMARY OF THE INVENTION

When a residual charge quantity in an electric vehicle is reduced, the electric vehicle is required to travel to a charging facility for charging using the residual charge quantity. In particular, if the electric vehicle repeats a round trip regularly for a purpose such as commuting or lessons for a child, for example, it is convenient if the electric vehicle is given guidance to a charging facility existing along a route of the round trip or near the route when a residual charge quantity is at an appropriate value.

An object of the present invention is to provide a charging facility guidance device, a charging facility guidance method, and a non-transitory computer-readable medium storing a program allowing an electric vehicle to be given guidance to a charging facility existing along a route of a round trip made repeatedly and regularly by the electric vehicle or near the route when a residual charge quantity is at an appropriate value.

To attain the foregoing object, an aspect of the present invention provides a charging facility guidance device 100 including: a communication unit (communication unit 110 described later, for example) that makes communication with a vehicle-installed communication device (vehicle-installed communication device 282 described later, for example) and with a charging facility (charging facility C described later, for example); a calculation unit (calculation unit 130 described later, for example) that calculates a route for charging in which the charging facility where an electric vehicle (electric vehicle 200 described later, for example) is to be charged is incorporated between a predetermined start point and a predetermined destination, on the basis of vehicle notification information stored in a storage unit (storage unit 160 described later, for example), received by the communication unit, and including identification information about the electric vehicle, positional information about the electric vehicle, information indicating a charging state of the electric vehicle, and round trip route information about a round trip between the predetermined start point and the predetermined destination, the round trip being made by the electric vehicle equipped with the vehicle-installed communication device; and a management unit (management unit 140 described later, for example) that outputs information about the route for charging calculated by the calculation unit.

Another aspect of the present invention provides a charging facility guidance method implemented by a charging facility guidance device including a communication unit that makes communication with a vehicle-installed communication device and with a charging facility. The method includes: calculating a route for charging in which the charging facility where an electric vehicle is to be charged is incorporated between a predetermined start point and a predetermined destination, on the basis of vehicle notification information stored in a storage unit, received by the communication unit, and including identification information about the electric vehicle, positional information about the electric vehicle, information indicating a charging state of the electric vehicle, and round trip route information about a round trip between the predetermined start point and the predetermined destination, the round trip being made by the electric vehicle equipped with the vehicle-installed communication device; and outputting information about the route for charging.

Yet another aspect of the present invention provides a non-transitory computer-readable medium storing a program for causing a charging facility guidance device to perform a process. The charging facility guidance device includes a communication unit that makes communication with a vehicle-installed communication device and with a charging facility.

The process includes: calculating a route for charging in which the charging facility where an electric vehicle is to be charged is incorporated between a predetermined start point and a predetermined destination, on the basis of vehicle notification information stored in a storage unit, received by the communication unit, and including identification information about the electric vehicle, positional information about the electric vehicle, information indicating a charging state of the electric vehicle, and round trip route information about a round trip between the predetermined start point and the predetermined destination, the round trip being made by the electric vehicle equipped with the vehicle-installed communication device; and outputting information about the route for charging.

Thus, if there arises a need to charge the electric vehicle on the way to work, for example, and if a residual charge quantity is such a quantity allowing the electric vehicle to arrive at the nearest charging facility in a self-propelled manner, the electric vehicle can be given guidance to the charging facility. In particular, a degree of traveling causing the need for charging can be calculated easily, particularly along a round trip route of a round trip made regularly by the electric vehicle, thereby providing appropriate timing for guiding the charging facility.

In this case, it is preferable that the calculation unit avoids incorporating a busy charging facility, and preferentially incorporates a charging facility having more room than the busy charging facility in the route for charging. This makes it possible to prevent the electric vehicles intended to be charged from concentrating on the predetermined charging facility.

In this case, the vehicle notification information preferably includes information about a state of use of the electric vehicle, and the calculation unit preferably calculates the charging facility to be incorporated in the route for charging on the basis of the vehicle notification information. Thus, a traveling distance permitted by a residual charge quantity in the electric vehicle can be calculated more correctly. As a result, it becomes possible to calculate a candidate for the charging facility to become reliably reachable by traveling in a self-propelled manner using electricity corresponding to the residual charge quantity.

In this case, it is preferable that a facility reservation unit (facility reservation unit 170 described later, for example) is further provided. The facility reservation unit communicates with the charging facility through the communication unit to make a reservation for charging at the charging facility along the route for charging calculated by the calculation unit. This makes it possible to avoid trouble occurring if all chargers are busy at the time of arrival at the charging facility, so that the electric vehicle can be charged reliably without delay at the charging facility.

The present invention allows provision of a charging facility guidance device, a charging facility guidance method, and a non-transitory computer-readable medium storing a program allowing an electric vehicle to be given guidance to a charging facility existing along a route of a round trip made repeatedly and regularly by the electric vehicle or near the route when a residual charge quantity is at an appropriate value.

### BRIEF DESCRIPTION OF THE DRAWINGS

FIG. 1 is a view of a vehicle system including a charging facility guidance device according to an embodiment of the present invention;

FIG. 2 shows the configuration of an electric vehicle that is not a self-driving vehicle to be guided by the charging facility guidance device according to the embodiment of the present invention;

FIG. 3 shows the configuration of an electric vehicle that is a self-driving vehicle to be guided by the charging facility guidance device according to the embodiment of the present invention;

FIG. 4 shows an example of vehicle information about an electric vehicle to be guided by the charging facility guidance device according to the embodiment of the present invention;

FIG. 5 shows an example of charging facility information in the charging facility guidance device according to the embodiment of the present invention;

FIG. 6 shows an example of vehicle notification information in the charging facility guidance device according to the embodiment of the present invention; and

FIG. 7 is a flowchart showing control relating to the charging facility guidance device according to the embodiment of the present invention.

### DETAILED DESCRIPTION OF THE INVENTION

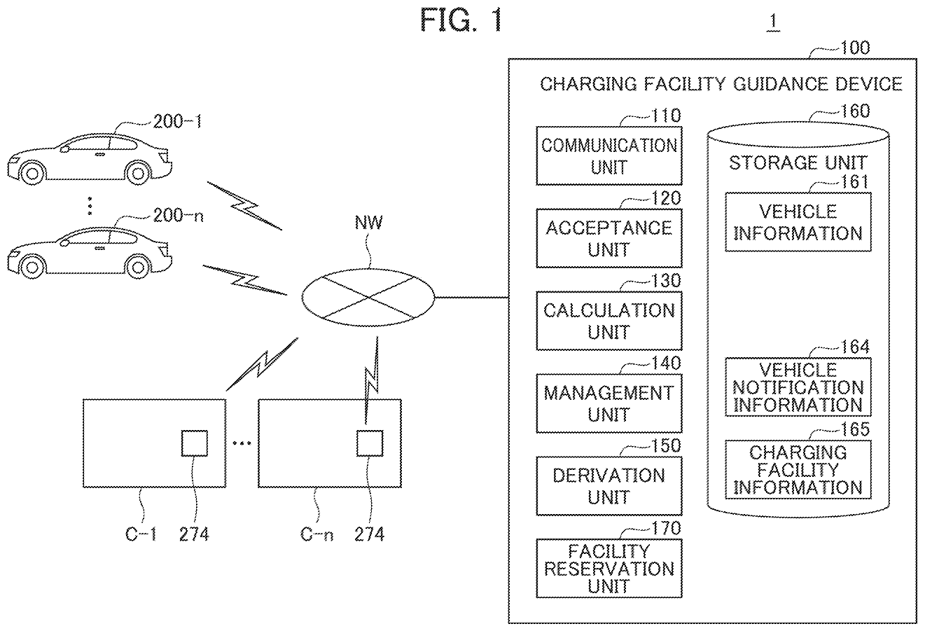

An embodiment of the present invention will be described in detail below by referring to the drawings. FIG. 1 is a view of a vehicle system 1 including a charging facility guidance device 100. In the embodiment described below, a route for commuting will be explained as a route for a round trip by an electric vehicle.

The vehicle system 1 of the embodiment includes the charging facility guidance device 100, electric vehicles 200-1 to 200-n (n is an integer of greater than 1), and a charging facility C. The charging facility guidance device 100, each of the electric vehicles 200-1 to 200-n, and each of charging facilities C-1 to C-n are communicable with each other through a network NW. The network NW includes the Internet, a wide area network (WAN), a local area network (LAN), a public line, a provider device, a dedicated line, a wireless base station, etc. In the embodiment, each of the electric vehicles 200-1 to 200-n stop at parking lots used by respective owners of the electric vehicles 200-1 to 200-n.

The charging facility C is a charging stand available for charging of an electric vehicle. As a specific example, the charging stand makes a reservation for charging for an electric vehicle with a reduced residual charge quantity capable of arriving at the charging stand in a self-propelled manner using electricity corresponding to the residual charge quantity, and charges the electric vehicle 200 guided by the charging facility guidance device 100. On the basis of the position of each of the electric vehicles 200-1 to 200-n and information indicating the charging state of each of the electric vehicles 200-1 to 200-n, the charging facility guidance device 100 gives the electric vehicle 200 guidance to the charging facility C reachable by the electric vehicle 200 using electricity corresponding to the residual charge quantity in the electric vehicle 200.

Each of the electric vehicles 200-1 to 200-n generates vehicle notification information including vehicle identification information, vehicle positional information, information indicating the charging state of a vehicle, round trip route information about a round trip between a predetermined start point and a predetermined destination made by the electric vehicle 200, and information about the state of use of the electric vehicle 200, and transmits the generated vehicle notification information to the charging facility guidance device 100. The charging facility guidance device 100 receives the vehicle notification information transmitted from each of the electric vehicles 200-1 to 200-n. The charging facility guidance device 100 acquires the vehicle identification information, the vehicle positional information, the information indicating the charging state of a vehicle, the round trip route information, and the information about the state of use of the electric vehicle 200 included in each of one or more of the acquired pieces of vehicle notification information. The charging facility guidance device 100 stores the acquired one or more pieces of vehicle identification information, vehicle positional information, information indicating the charging state of a vehicle, round trip route information, and information about the state of use of the electric vehicle 200 in association with each other.

Each of the electric vehicles 200-1 to 200-n may or may not be a self-driving vehicle. Using a self-driving vehicle as an electric vehicle to be given guidance allows the electric vehicle to be guided to the charging facility C while a residual charge quantity is at an appropriate value.

If a residual charge quantity in the transmitted vehicle notification information about each of the electric vehicles 200-1 to 200-n is small and thus this electric vehicle 200 is required to be charged, this electric vehicle 200 transmits a guidance instruction to the charging facility guidance device 100 for instructing guidance of the electric vehicle 200 to the charging facility C at an appropriate position from the electric vehicle 200.

The charging facility guidance device 100 derives an arrival time indicating a time when the electric vehicle to be guided can arrive at the position of the predetermined charging facility C on the basis of the position of the electric vehicle to be guided and the position of the predetermined charging facility C. The charging facility guidance device 100 generates a vehicle response directed to the electric vehicles 200-1 to 200-n including information indicating that the guidance has been instructed and information indicating the arrival time, and transmits the generated vehicle response to the electric vehicles 200-1 to 200-n.

The following describes the details of the electric vehicles 200-1 to 200-n, the charging facility guidance device 100, and the charging facilities C-1 to C-n included in the vehicle system 1. An optional electric vehicle belonging to the electric vehicles 200-1 to 200-n will be called an electric vehicle 200. Likewise, an optional charging facility belonging to the charging facilities C-1 to C-n will be called a charging facility C.

### [Electric Vehicle 200]

The electric vehicle 200 included in the vehicle system 1 is a four-wheel mobile unit, for example. The electric vehicle 200 is a battery electric vehicle including at least a secondary cell and traveling by driving a motor using electric power stored in the secondary cell, or a hybrid vehicle configured to be driven by a motor and to receive power feeding from outside.

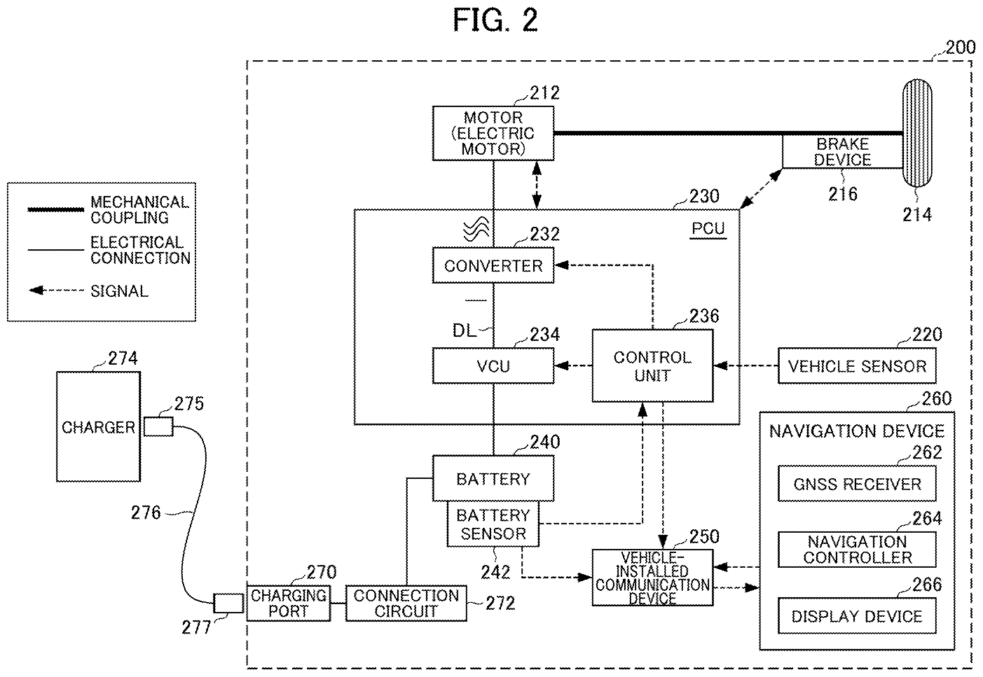

FIG. 2 shows a first example of the configuration of the electric vehicle according to the embodiment. The electric vehicle 200 shown in FIG. 2 is a vehicle which is not a self-driving vehicle. As shown in FIG. 2, the electric vehicle 200 includes a motor 212, a drive wheel 214, a brake device 216, a vehicle sensor 220, a power controller (PCU) 230, a battery 240, a battery sensor 242 that may be a voltage sensor, a current sensor, or a temperature sensor, for example, a vehicle-installed communication device 250, a navigation device 260, a charging port 270, and a connection circuit 272, for example.

The motor 212 is a three-phase AC motor, for example. The motor 212 has a rotor coupled to the drive wheel 214. The motor 212 outputs drive power to the drive wheel 214 using electric power supplied to the motor 212. The motor 212 generates power using the kinetic energy of the electric vehicle during deceleration of the electric vehicle.

The brake device 216 includes a brake caliper, a cylinder that transmits hydraulic pressure to the brake caliper, and an electric motor that generates the hydraulic pressure at the cylinder, for example. The brake device 216 may include a mechanism as a backup to transmit hydraulic pressure generated by operation on a brake pedal to the cylinder through a master cylinder. The brake device 216 is not limited to the configuration described above but may be an electronically-controlled hydraulic brake device that transmits hydraulic pressure at the master cylinder to the cylinder.

The vehicle sensor 220 includes an accelerator position sensor, a vehicle speed sensor, and a brake depression amount sensor. The accelerator position sensor is an example of an operator that accepts an instruction for acceleration from a driver. The accelerator position sensor is attached to an accelerator pedal, detects the amount of operation on the accelerator pedal, and outputs the detected amount of operation on the accelerator pedal as an accelerator position to a control unit 236. The vehicle speed sensor includes wheel speed sensors attached to respective wheels and a speed calculator, for example. The vehicle speed sensor integrates wheel speeds detected by the wheel speed sensors to calculate the speed of the electric vehicle (vehicle speed), and outputs the calculated speed to the control unit 236. The brake depression amount sensor is attached to a brake pedal, detects the amount of operation on the brake pedal, and outputs the detected amount of operation on the brake pedal as a brake depression amount to the control unit 236.

The PCU 230 includes a converter 232, a voltage controller (VCU) 234, and the control unit 236, for example. The configuration of providing these constituting elements in a unified manner as the PCU 230 is merely shown as an example. These constituting elements may be arranged separately.

The converter 232 is an AC-DC converter, for example. The converter 232 has a DC-side terminal connected to a DC link DL. The battery 240 is connected to the DC link DL through the VCU 234. The converter 232 converts an alternating current generated by the motor 212 to a direct current, and outputs the resultant direct current to the DC link DL.

The VCU 234 is a DC-DC converter, for example. The VCU 234 boosts electric power supplied from the battery 240, and outputs the boosted electric power to the DC link DL.

The control unit 236 includes a motor control unit, a brake control unit, and a battery/VCU control unit, for example. The motor control unit, the brake control unit, and the battery/VCU control unit may be replaced with respective separated controllers that may be controllers such as a motor ECU, a brake ECU, and a battery ECU, for example.

The motor control unit controls the motor 212 on the basis of output from the vehicle sensor 220. The brake control unit controls the brake device 216 on the basis of output from the vehicle sensor 220. The battery/VCU control unit calculates the state of charge (SOC) of the battery 240 on the basis of output from the battery sensor 242 attached to the battery 240, and outputs a calculation result about the SOC to the VCU 234 and to the vehicle-installed communication device 250. The SOC is an example of information indicating the charging state of the battery 240. The VCU 234 increases a voltage at the DC link DL in response to an instruction from the battery/VCU control unit.

The battery 240 is a secondary cell such as a lithium-ion cell, for example. The battery 240 stores electric power introduced from a charger 274 outside the electric vehicle 200, and discharges energy for causing the electric vehicle 200 to travel.

The navigation device 260 includes a GNSS receiver 262, a navigation controller 264, and a display device 266, for example. The GNSS receiver 262 measures the position of a machine (the position of the electric vehicle 200) on the basis of a radio wave coming from a GNSS satellite (a GPS satellite, for example). The navigation controller 264 includes a CPU and various types of storage devices, for example, and controls the navigation device 260 entirely. The storage device stores map information (navigation map). The navigation map is a map including roads expressed by nodes and links. On the basis of the position of the electric vehicle 200 measured by the GNSS receiver 262, the navigation controller 264 decides a route to a destination by referring to the navigation map. The destination mentioned herein may be designated using positional information about the electric vehicle 200 included in a guidance instruction. The navigation controller 264 may transmit the position of the electric vehicle 200 and a destination to a navigation server (not shown) using the vehicle-installed communication device 250, and acquire a route transmitted as a reply from the navigation server. The navigation controller 264 outputs information about the route decided by any of the foregoing methods to the display device 266. The display device 266 displays the information corresponding to the control by the navigation controller 264. The display device 266 displays a navigation screen in response to the information output from the navigation controller 264. The GNSS receiver 262 outputs positional information corresponding to a measurement result about the position of the electric vehicle 200 to the vehicle-installed communication device 250.

The battery sensor 242 includes a sensor such as a current sensor, a voltage sensor, or a temperature sensor, for example. The battery sensor 242 detects the current value, voltage value, and temperature of the battery 240, for example. The battery sensor 242 outputs the detected current value and voltage value, and information about the detected temperature to the control unit 236 and to the vehicle-installed communication device 250. The battery sensor 242 may include a plurality of sensors, such as a current sensor, a voltage sensor, or a temperature sensor, respectively. In the presence of a plurality of such sensors as the battery sensor 242, a battery sensor identifier may be given to each of a current value, a voltage value, and information indicating a temperature to be output to the control unit 236. The battery sensor identifier is an identifier allowing a plurality of the sensors provided in the electric vehicle 200 to be discriminated from each other. The battery sensor identifier may be expressed by alphanumeric characters determined in advance, for example.

The vehicle-installed communication device 250 includes a wireless module used for making a connection to the Internet, a WAN, a LAN, a public line, a provider device, a dedicated line, or a wireless base station, for example. The vehicle-installed communication device 250 acquires a current value, a voltage value, and information indicating a temperature output from the battery sensor 242. The vehicle-installed communication device 250 acquires a calculation result about an SOC output from the control unit 236. The vehicle-installed communication device 250 acquires positional information about the electric vehicle 200 output from the GNSS receiver 262. The vehicle-installed communication device 250 generates vehicle notification information directed to the charging facility guidance device 100 including the acquired current value, voltage value, and information indicating a temperature, the acquired information indicating the charging state of the electric vehicle 200 such as the SOC, and the acquired positional information about the electric vehicle 200. The vehicle-installed communication device 250 transmits the generated vehicle notification information to the charging facility guidance device 100 through the network NW shown in FIG. 1.

The charging port 270 is provided to be pointed toward the outside of the vehicle body of the electric vehicle 200. The charging port 270 is connected to the charger 274 through a charging cable 276. The charging cable 276 includes a first plug 275 and a second plug 277. The first plug 275 is connected to the charger 274, and the second plug 277 is connected to the charging port 270. Electricity from the charger 274 is supplied to the charging port 270 through the charging cable 276. The charger 274 is an example of the charging facility C. The charging cable 276 includes a signal cable attached to a power cable. The signal cable mediates communication between the electric vehicle 200 and the charger 274. To achieve this, the first plug 275 and the second plug 277 respectively are provided with a power connector and a signal connector.

The connection circuit 272 is provided between the charging port 270 and the battery 240. The connection circuit 272 transmits a current such as a DC current, for example, introduced into the connection circuit 272 from the charger 274 through the charging port 270. The connection circuit 272 transmits the DC current to the battery 240.

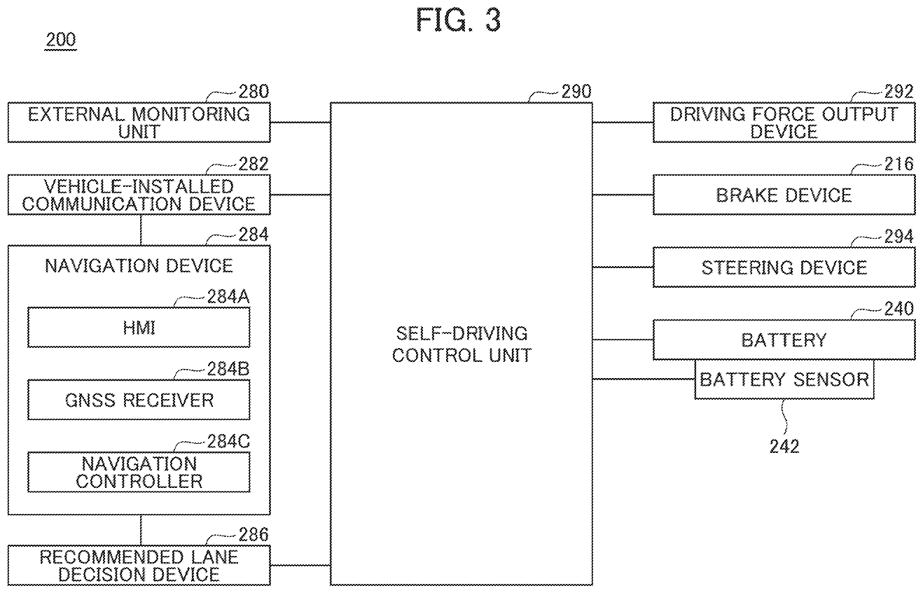

As shown in FIG. 3, the electric vehicle 200 which is a self-driving vehicle includes an external monitoring unit 280, a vehicle-installed communication device 282, a navigation device 284, a recommended lane decision device 286, a self-driving control unit 290, a driving force output device 292, a brake device 216, a steering device 294, a battery 240, and a battery sensor 242, for example. FIG. 3 shows the configuration of the electric vehicle 200 that is a self-driving vehicle to be guided by the charging facility guidance device 100.

The external monitoring unit 280 forms a situation acquisition device, and includes a camera, a radar, a light detection and ranging (LIDAR) unit, and an object recognition device that performs sensor fusion process on the basis of outputs from these units, for example. The external monitoring unit 280 estimates the type of an object existing around the electric vehicle 200 (in particular, an electric vehicle, a pedestrian, or a bicycle, for example) to generate estimated information (situation information), and outputs the estimated information together with information about the position or speed of the object to the self-driving control unit 290.

The vehicle-installed communication device 282 is a wireless communication module for making a connection to the network NW or making direct communication with a different electric vehicle or a terminal device of a pedestrian, for example. The vehicle-installed communication device 282 makes wireless communication based on Wi-Fi, dedicated short range communications (DSRC), Bluetooth (registered trademark), or other types of communication standards. Two or more types of devices may be prepared as the vehicle-installed communication device 282. The vehicle-installed communication device 282 acquires a current value, a voltage value, and information indicating a temperature output from the self-driving control unit 290. The vehicle-installed communication device 282 acquires a calculation result about an SoC output from the self-driving control unit 290. The vehicle-installed communication device 282 acquires positional information about the electric vehicle 200 output from a GNSS receiver 284B. The vehicle-installed communication device 282 generates vehicle notification information directed to the charging facility guidance device 100 including the acquired current value, voltage value, and information indicating a temperature, the acquired information indicating the charging state of the electric vehicle 200 such as the SOC, the acquired positional information about the electric vehicle 200, and the estimated information generated by the external monitoring unit 280. The vehicle-installed communication device 282 transmits the generated vehicle notification information to the charging facility guidance device 100 through the network NW shown in FIG. 1.

The navigation device 284 includes a human machine interface (HMI) 284A, the GNSS receiver 284B, and a navigation controller 284C, for example. The HMI 284A includes a touch-panel display device, a speaker, a microphone, etc., for example. The GNSS receiver 284B measures the position of a machine (the position of the electric vehicle 200) on the basis of a radio wave coming from a GNSS satellite (a GPS satellite, for example). The navigation controller 284C includes a CPU and various types of storage devices, for example, and controls the navigation device 284 entirely. The storage device stores map information (navigation map). The navigation map is a map including roads expressed by nodes and links. On the basis of the position of the electric vehicle 200 measured by the GNSS receiver 284B, the navigation controller 284C decides a route to a destination by referring to the navigation map. The destination mentioned herein may be designated using the HMI 284A or may be designated using positional information about the electric vehicle 200 included in a guidance instruction. The navigation controller 284C may transmit the position of the electric vehicle 200 and a company (place of employment) as a destination to a navigation server (not shown) using the vehicle-installed communication device 282, and acquire a route transmitted as a reply from the navigation server. The route may include information about a stopping point for getting on or getting off by an owner of the electric vehicle 200, and an intended arrival time. The navigation controller 284C outputs information about the route decided by any of the foregoing methods to the recommended lane decision device 286.

The recommended lane decision device 286 includes a map positioning unit (MPU) and various types of storage devices, for example. The storage device includes highly accurate map information covering further details than the navigation map. The highly accurate map information includes information such as a road width, a grade, a curvature, and positions of signals about each lane, for example. The recommended lane decision device 286 decides a recommended lane preferable for traveling along a route input from the navigation device 284, and outputs the decided recommended lane to the self-driving control unit 290.

The self-driving control unit 290 includes one or more processors such as a CPU or an MPU, and various types of storage devices. On the principle of traveling along the recommended lane decided by the recommended lane decision device 286, the self-driving control unit 290 causes the electric vehicle 200 to travel automatically in such a manner as to avoid contact with an object at a position or speed input from the external monitoring unit 280. The self-driving control unit 290 performs various types of events sequentially, for example. The events include a constant-speed traveling event of traveling along one traveling lane at a constant speed, a tracking traveling event of traveling while tracking a vehicle traveling ahead, a lane changing event, a merging event, a branching event, an emergency stopping event, a tollgate event for passing through a tollgate, and a handover event for finishing self-driving and making a switch to manual driving, for example. During implementations of these events, action for the avoidance may be planned on the basis of a situation around the electric vehicle 200 (the presence of a neighboring vehicle or pedestrian, lane narrowing resulting from a roadwork, for example).

The self-driving control unit 290 generates an intended orbit in which the electric vehicle 200 is to travel in the future. The intended orbit includes a speed element, for example. For example, the intended orbit is expressed by a line of sequentially arranged points (orbital points) to be reached by the electric vehicle 200. The orbital points are points to be reached by the electric vehicle 200 and are defined at a predetermined traveling distance. Separately from the orbital points, an intended speed and an intended acceleration defined for each predetermined sampling period (a few tenths of a second, for example) are generated as part of the intended orbit. The orbital points may be positions to be reached by the electric vehicle 200 at the time of sampling in each predetermined period of the sampling. In this case, information such as an intended speed and an intended acceleration is expressed using an interval between the orbital points. The self-driving control unit 290 calculates the SOC of the battery 240 on the basis of output from the battery sensor 242 attached to the battery 240, and outputs a calculation result about the SOC to the vehicle-installed communication device 282. The self-driving control unit 290 outputs a current value, a voltage value, and information indicating a temperature output from the battery sensor 242 to the vehicle-installed communication device 282.

The battery 240 is a secondary cell such as a lithium-ion cell, for example. The battery 240 stores electric power introduced from a charger outside the electric vehicle 200, and discharges energy for causing the electric vehicle 200 to travel.

The battery sensor 242 includes a sensor such as a current sensor, a voltage sensor, or a temperature sensor, for example. The battery sensor 242 detects the current value, voltage value, and temperature of the battery 240, for example. The battery sensor 242 outputs the detected current value and voltage value, and information about the detected temperature to the self-driving control unit 290. The battery sensor 242 may include a plurality of sensors, such as a current sensor, a voltage sensor, or a temperature sensor, respectively. In the presence of a plurality of such sensors as the battery sensor 242, a battery sensor identifier may be given to each of a current value, a voltage value, and information indicating a temperature to be output to the self-driving control unit 290. The battery sensor identifier is an identifier allowing a plurality of the sensors provided in the electric vehicle 200 to be discriminated from each other. The battery sensor identifier may be expressed by alphanumeric characters determined in advance, for example.

An example of a self-driving operation process by the electric vehicle 200 will be described. First, the navigation device 284 decides a route. This route is a rough route without distinction of lanes, for example. Next, the recommended lane decision device 286 decides a recommended lane that facilitates traveling along the route. Then, the self-driving control unit 290 generates orbital points for traveling along the recommended lane as correctly as possible while avoiding an obstacle, for example, and controls some or all of the driving force output device 292, the brake device 216, and the steering device 294 in order to achieve traveling along the orbital points (and along an accompanying speed profile). Such role sharing is merely shown as an example. The self-driving control unit 290 may perform the process in a centralized manner, for example.

The driving force output device 292 outputs traveling driving force (torque) to drive wheels for causing the electric vehicle to travel. The driving force output device 292 includes a combination of an internal combustion engine, a motor, and a transmission, etc., and a power ECU for controlling these units, for example. The power ECU controls the configuration described above in response to information input from the self-driving control unit 290 or information input from a driving operator not shown.

The brake device 216 includes a brake caliper, a cylinder that transmits hydraulic pressure to the brake caliper, an electric motor that generates the hydraulic pressure at the cylinder, and a brake ECU, for example. The brake ECU controls the electric motor in response to information input from the self-driving control unit 290 or information input from a driving operator, and causes a brake torque responsive to a braking operation to be output to each wheel. The brake device 216 may include a mechanism as a backup to transmit hydraulic pressure generated by operation on a brake pedal included in the driving operator to the cylinder through a master cylinder. The brake device 216 is not limited to the configuration described above but may be an electronically-controlled hydraulic brake device that controls an actuator in response to information input from the self-driving control unit 290 and transmits hydraulic pressure at the master cylinder to the cylinder.

The steering device 294 includes a steering ECU and an electric motor, for example. The electric motor causes force to act on a rack-and-pinion mechanism to change the direction of a turning wheel, for example. The steering ECU drives the electric motor in response to information input from the self-driving control unit 290 or information input from a driving operator, and changes the direction of the turning wheel.

### [Charging Facility Guidance Device 100]

The charging facility guidance device 100 is realized using a device such as a personal computer, a server, or an industrial computer, for example. The charging facility guidance device 100 includes a communication unit 110, an acceptance unit 120, a calculation unit 130, a management unit 140, a derivation unit 150, a storage unit 160, and a facility reservation unit 170, for example.

The communication unit 110 is realized using a communication module. More specifically, the communication unit 110 is configured using a device to make wire communication. The communication unit 110 may be configured using a wireless device to make wireless communication by a wireless communication technique such as LTE or a wireless LAN, for example. The communication unit 110 communicates through the network NW with the charging facility C, with the vehicle-installed communication device 250 in the electric vehicle 200 which is not a self-driving vehicle, and with the vehicle-installed communication device 282 in the electric vehicle 200 which is a self-driving vehicle. More specifically, the communication unit 110 receives vehicle notification information transmitted from the vehicle-installed communication device 250 in the electric vehicle 200 which is not a self-driving vehicle and vehicle notification information transmitted from the vehicle-installed communication device 282 in the electric vehicle 200 which is a self-driving vehicle, and outputs the received vehicle notification information to the acceptance unit 120. The communication unit 110 acquires a guidance instruction output from the management unit 140, and transmits the acquired guidance instruction to the electric vehicle 200 to be guided. The communication unit 110 acquires a vehicle response output from the management unit 140, and transmits the acquired vehicle response to the electric vehicle 200.

The storage unit 160 is realized using a hard disk drive (HDD), a flash memory, a random access memory (RAM), or a read only memory (ROM), for example. The storage unit 160 stores vehicle information 161, charging facility information 162, and vehicle notification information 164. The vehicle information 161, the charging facility information 162, and the vehicle notification information 164 may be stored on the cloud.

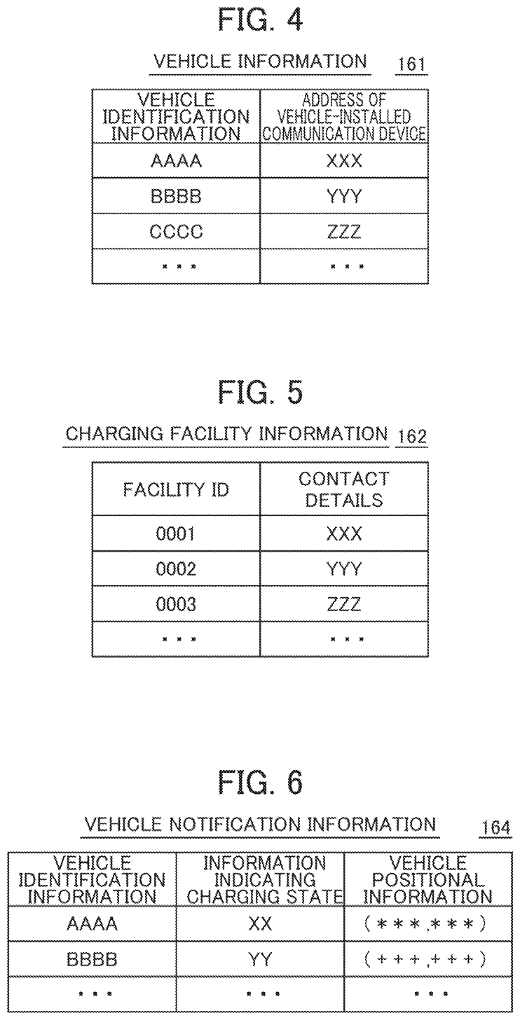

FIG. 4 shows an example of vehicle information. The vehicle information 161 is information in a table format including vehicle identification information about the electric vehicle 200 and an address of a vehicle-installed communication device installed on the electric vehicle 200 stored in association with each other. An example of an address of the vehicle-installed communication device is an IP address. In the example shown in FIG. 4, the vehicle information 161 includes vehicle identification information “AAAA” about the electric vehicle 200 and an address “XXX” of a vehicle-installed communication device stored in association with each other, vehicle identification information “BBBB” about the electric vehicle 200 and an address “YYY” of a vehicle-installed communication device stored in association with each other, and vehicle identification information “CCCC” about the electric vehicle 200 and an address “ZZZ” of a vehicle-installed communication device stored in association with each other. These pieces of information are registered at the time of introduction of the electric vehicle 200 into the vehicle system 1.

FIG. 5 shows an example of charging facility information. The charging facility information 162 is information in a table format including a facility ID and contact details for the charging facility C corresponding to the charging facility ID stored in association with each other. An example of contact details for the charging facility C is a postal address and an e-mail address. In the example shown in FIG. 5, the charging facility information 162 includes a charging facility ID “0001” and contact details “XXX” stored in association with each other, a charging facility ID “0002” and contact details “YYY” stored in association with each other, and a charging facility ID “0003” and contact details “ZZZ” stored in association with each other. These pieces of information are registered when the charging facility C is installed on the vehicle system 1.

FIG. 6 shows an example of vehicle notification information. The vehicle notification information 164 is information in a table format including vehicle identification information about the electric vehicle 200, information indicating the charging state of the electric vehicle 200, and vehicle positional information about the electric vehicle 200 stored in association with each other. An example of vehicle positional information about the electric vehicle 200 is expressed as (longitude, latitude). In the example shown in FIG. 6, the vehicle notification information 164 includes vehicle identification information “AAAA” about the electric vehicle 200, information “XX” indicating the charging state of the electric vehicle 200, and vehicle positional information “(***, ***)” about the electric vehicle 200 stored in association with each other, and vehicle identification information “BBBB” about the electric vehicle 200, information “YY” indicating the charging state of the electric vehicle 200, and vehicle positional information “(+++, +++)” about the electric vehicle 200 stored in association with each other. The information “XX” indicating the charging state of the electric vehicle 200 is the state of charge of a secondary cell (battery 240) in the electric vehicle 200, for example. These pieces of information are updated on the basis of vehicle notification information transmitted from the electric vehicle 200.

The acceptance unit 120, the calculation unit 130, the management unit 140, and the derivation unit 150 are realized by causing a hardware processor such as a central processing unit (CPU) to execute a program (software) stored in the storage unit 160, for example. Some or all of these functional units may be realized using hardware (circuit section including circuitry) such as a large scale integration (LSI), an application specific integrated circuit (ASIC), a field-programmable gate array (FPGA), or a graphics processing unit (GPU), for example, or may be realized by causing software and hardware working cooperatively. The program may be stored in advance in a storage device (a storage device with a non-transitory storage medium) such as a hard disk drive (HDD) or a flash memory. Alternatively, the program may be stored in an attachable/detachable storage medium (a non-transitory storage medium) such as a DVD or a CD-ROM, and may be installed by attaching the storage medium to a drive.

The following describes the details of the acceptance unit 120, the calculation unit 130, the management unit 140, and the derivation unit 150. The vehicle-installed communication device 250 of the electric vehicle 200 acquires vehicle identification information, information indicating a charging state, positional information about the electric vehicle 200, round trip route information about a round trip between a predetermined start point and a predetermined destination having been made so far regularly by the electric vehicle 200, and information about the state of use of the electric vehicle 200 indicating a way in which the electric vehicle 200 has been used so far, namely, indicating how the electric vehicle 200 has been accelerated and decelerated during traveling of the electric vehicle 200. Then, the vehicle-installed communication device 250 generates vehicle notification information directed to the charging facility guidance device 100 including the acquired vehicle identification information, information indicating a charging state, positional information about the electric vehicle 200, round trip route information, and information about the state of use of the electric vehicle 200. The vehicle-installed communication device 250 transmits the generated vehicle notification information to the charging facility guidance device 100. The communication unit 110 of the charging facility guidance device 100 receives the vehicle notification information transmitted from the vehicle-installed communication device 250, and outputs the received vehicle notification information to the acceptance unit 120.

The vehicle-installed communication device 282 of the electric vehicle 200 acquires vehicle identification information, information indicating a charging state, positional information about the electric vehicle 200, round trip route information, and information about the state of use of the electric vehicle 200, and generates vehicle notification information directed to the charging facility guidance device 100 including the acquired vehicle identification information, information indicating a charging state, positional information about the electric vehicle 200, round trip route information, and information about the state of use of the electric vehicle 200. The vehicle-installed communication device 282 transmits the generated vehicle notification information to the charging facility guidance device 100. The communication unit 110 of the charging facility guidance device 100 receives the vehicle notification information transmitted from the vehicle-installed communication device 232, and outputs the received vehicle notification information to the acceptance unit 120.

The acceptance unit 120 acquires the vehicle notification information output from the communication unit 110, and acquires the vehicle identification information, the information indicating a charging state, the positional information about the electric vehicle 200, the round trip route information, and the information about the state of use of the electric vehicle 200 included in the acquired vehicle notification information. The acceptance unit 120 stores the acquired vehicle identification information, information indicating a charging state, positional information about the electric vehicle 200, round trip route information, and information about the state of use of the electric vehicle 200 in association with each other into the vehicle notification information 164 in the storage unit 160.

The storage unit 160 stores information about the charging facility C. The information about the charging facility C is the facility ID and contact details with the charging facility C. The information about the charging facility C is received by the communication unit 110 of the charging facility guidance device 100. The communication unit 110 outputs the received information about the charging facility C to the acceptance unit 120. The acceptance unit 120 acquires the information about the charging facility C output from the communication unit 110, and stores the acquired information into the charging facility information 162 in the storage unit 160.

On the basis of the vehicle notification information 164 and the charging facility information 162, the calculation unit 130 calculates a route for charging in which the charging facility C where the electric vehicle 200 is to be charged is incorporated between a home which is a predetermined start point and a company (place of employment) which is a predetermined destination.

More specifically, on the basis of vehicle positional information associated with vehicle identification information, and information indicating a charging state, round trip route information, and information about the state of use of the electric vehicle 200 associated with vehicle identification information other than the former vehicle identification information, and using the vehicle notification information 164 in the storage unit 160, the calculation unit 130 calculates a route for charging in which the charging facility C where the electric vehicle 200 is to be charged is incorporated in a round trip route between a predetermined start point and a predetermined destination having regularly been used so far for making a round trip by this electric vehicle 200.

More specifically, the calculation unit 130 calculates a residual charge quantity from a current charging state using the vehicle notification information 164, and selects a plurality of candidates for the charging facility C reachable by the electric vehicle 200 in a self-propelled manner on the basis of the state of use of the electric vehicle 200 and the residual charge quantity. Next, the calculation unit 130 determines on the basis of the charging facility information 162 whether the predetermined charging facility C belonging to these candidates for the charging facility C has more room than the other charging facilities C, namely, determines whether the number of the chargers 274 not being used at the predetermined charging facility C is larger than the numbers of the chargers 274 not being used at the other charging facilities C, and selects the charging facility C having the most room.

The calculation unit 130 of the charging facility guidance device 100 calculates a route for charging in which the selected charging facility C is incorporated in the foregoing round trip route. The calculation unit 130 outputs the calculated route for charging to the management unit 140 and the facility reservation unit 170. The management unit 140 outputs a vehicle response including the generated route for charging to the communication unit 110. The communication unit 110 acquires the vehicle response output from the calculation unit 130, and transmits the acquired vehicle response to the electric vehicle 200.

(Operation of Vehicle System, Charging Facility Guidance Method, and Program for Causing a Charging Facility Guidance Device to Operate for Executing Charging Facility Guidance Method)

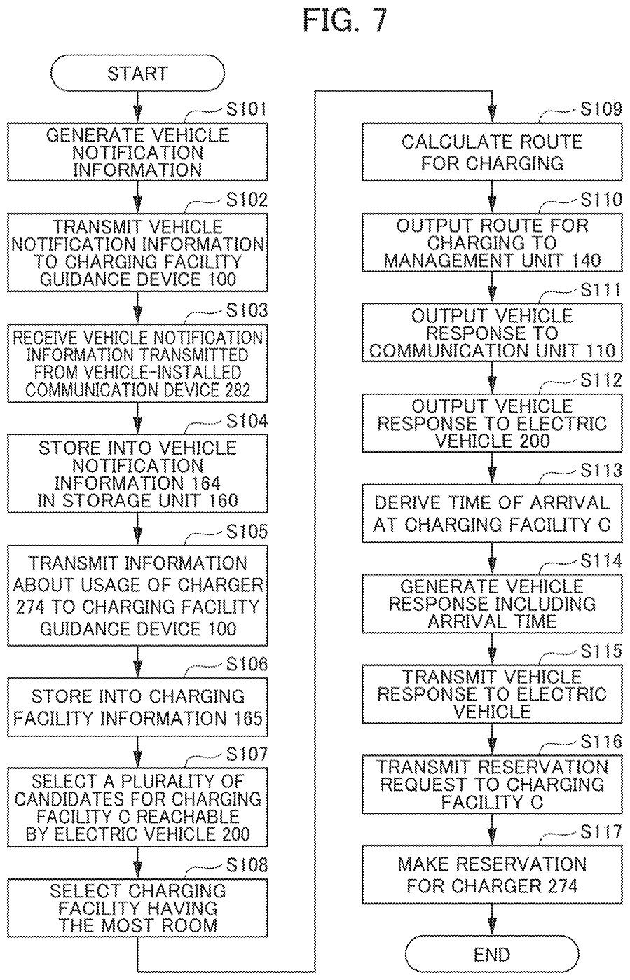

FIG. 7 is a flowchart showing control relating to the charging facility guidance device 100.

In the electric vehicle 200-1, the vehicle-installed communication device 250 acquires positional information about the electric vehicle 200-1 output from the GNSS receiver 262, an SOC output from the control unit 236, and a current value, a voltage value, and information indicating a temperature output from the battery sensor 242. The vehicle-installed communication device 250 generates vehicle notification information directed to the charging facility guidance device 100 including the acquired positional information, current value, voltage value, information indicating a temperature, information indicating a charging state such as the SOC about the electric vehicle 200-1, round trip route information about a round trip between a predetermined start point and a predetermined destination having been made so far regularly by the electric vehicle 200-1, and information about the state of use of the electric vehicle 200-1 indicating a way in which the electric vehicle 200-1 has been used so far, namely, indicating how the electric vehicle 200-1 has been accelerated and decelerated during traveling of the electric vehicle 200-1 (step S101).

In the electric vehicle 200-1, the vehicle-installed communication device 250 transmits the generated vehicle notification information to the charging facility guidance device 100 (step 3102).

In the charging facility guidance device 100, the communication unit 110 receives the vehicle notification information transmitted from the vehicle-installed communication device 250 (step S103).

In the charging facility guidance device 100, the communication unit 110 outputs the received vehicle notification information to the acceptance unit 120. The acceptance unit 120 acquires the vehicle notification information output from the communication unit 110, and acquires vehicle identification information, the vehicle positional information, the information indicating a charging state, the round trip route information, and the information about the state of use of the electric vehicle included in the acquired vehicle notification information. The acceptance unit 120 stores the acquired vehicle identification information, vehicle positional information, and information indicating a charging state in association with each other into the vehicle notification information 164 in the storage unit 160 (step S104). In each of the electric vehicles from 200-2 to 200-n-1, processes similar to those in steps S101 to S104 are also performed. In the following description of similar steps, the similar steps will be given the same step numbers starting from “S”.

In the electric vehicle 200-n, the vehicle-installed communication device 282 acquires positional information about the electric vehicle 200-n output from the GNSS receiver 234B, an SOC output from the self-driving control unit 290, a current value, a voltage value, and information indicating a temperature. The vehicle-installed communication device 282 generates vehicle notification information directed to the charging facility guidance device 100 including the acquired positional information about the electric vehicle 200-n, current value, voltage value, information indicating a temperature, information indicating a charging state such as the SOC about the electric vehicle 200-n, round trip route information about a round trip between a predetermined start point and a predetermined destination having been made so far regularly by the electric vehicle 200-n, and information about the state of use of the electric vehicle 200-n indicating a way in which the electric vehicle 200-n has been used so far, namely, indicating how the electric vehicle 200-n has been accelerated and decelerated during traveling of the electric vehicle 200-n (step S101).

In the electric vehicle 200-n, the vehicle-installed communication device 282 transmits the generated vehicle notification information to the charging facility guidance device 100 (step S102).

In the charging facility guidance device 100, the communication unit 110 receives the vehicle notification information transmitted from the vehicle-installed communication device 232 (step S103).

In the charging facility guidance device 100, the communication unit 110 outputs the received vehicle notification information to the acceptance unit 120. The acceptance unit 120 acquires the vehicle notification information output from the communication unit 110, and acquires vehicle identification information, the vehicle positional information, the information indicating a charging state, the round trip route information, and the information about the state of use of the electric vehicle included in the acquired vehicle notification information. The acceptance unit 120 stores the acquired vehicle identification information, vehicle positional information, and information indicating a charging state in association with each other into the vehicle notification information 164 in the storage unit 160 (step S104).

The charging facility C transmits information about the usage of the charger 274 indicating whether the charger 274 at the charging facility C is being used for charging the electric vehicle 200, namely, information about the number of the chargers 274 not being used for charging the electric vehicle 200 to the charging facility guidance device 100 (step S105).

In the charging facility guidance device 100, the communication unit 110 outputs the received information about the usage of the charger 274 to the acceptance unit 120. The acceptance unit 120 acquires the information about the usage of the charger 274 output from the communication unit 110, and acquires charging facility information and charging facility positional information included in the acquired information about the usage of the charger 274. The acceptance unit 120 stores the charging facility information and the charging facility positional information included in the acquired information about the usage of the charger 274 in association with each other into the charging facility information 162 in the storage unit 160 (step S106).

In the charging facility guidance device 100, the calculation unit 130 acquires vehicle identification information associated with vehicle notification information stored in the vehicle notification information 164 in the storage unit 160. On the basis of vehicle positional information associated with the acquired vehicle identification information, and information indicating a charging state, round trip route information, and information about the state of use of the electric vehicle 200 associated with vehicle identification information other than the former vehicle identification information, and using the vehicle notification information 164 in the storage unit 160, the calculation unit 130 calculates a route for charging in which the charging facility C where the electric vehicle 200 is to be charged is incorporated in a round trip route between a predetermined start point and a predetermined destination having regularly been used so far for making a round trip by this electric vehicle 200.

More specifically, the calculation unit 130 first calculates a residual charge quantity from a current charging state and using the vehicle notification information 164, and selects a plurality of candidates for the charging facility C reachable by the electric vehicle 200 in a self-propelled manner on the basis of the state of use of the electric vehicle 200 and the residual charge quantity (step S107). Next, the calculation unit 130 determines on the basis of the charging facility information 162 whether the predetermined charging facility C belonging to these candidates for the charging facility C has more room than the other charging facilities C, namely, determines whether the number of the chargers 274 not being used at the predetermined charging facility C is larger than the numbers of the chargers 274 not being used at the other charging facilities C, and selects the charging facility C having the most room (step S108).

Then, the calculation unit 130 of the charging facility guidance device 100 calculates a route for charging in which the selected charging facility C is incorporated in the foregoing round trip route (step 3109). The calculation unit 130 outputs the calculated route for charging to the management unit 140 and the facility reservation unit 170 (step S110). The management unit 140 outputs a vehicle response including the generated route for charging to the communication unit 110 (step S111). The communication unit 110 acquires the vehicle response output from the calculation unit 130, and transmits the acquired vehicle response to the electric vehicle 200 (step S112).

In the charging facility guidance device 100, the management unit 140 outputs positional information about the selected charging facility C to the derivation unit 150. The derivation unit 150 acquires the positional information about the selected charging facility C output from the management unit 140, and derives a time of arrival to the charging facility C on the basis of the acquired positional information about the selected charging facility C and vehicle positional information about the electric vehicle to be guided (step S113).

In the charging facility guidance device 100, the derivation unit 150 outputs information indicating the derived arrival time to the management unit 140. The management unit 140 acquires the information indicating the arrival time output from the derivation unit 150. The management unit 140 generates a vehicle response directed to the electric vehicles 200 including information indicating that guidance has been instructed and the information indicating the arrival time (step S114).

In the charging facility guidance device 100, the management unit 140 outputs the generated vehicle response to the communication unit 110. The communication unit 110 acquires the vehicle response output from the management unit 140, and transmits the acquired vehicle response to the electric vehicle 200 (step S115). As a result of the foregoing, the electric vehicle 200 is given guidance to a route in which the charging facility C is incorporated between a home which is a predetermined start point and a company (place of employment) which is a predetermined destination and along which this electric vehicle 200 has repeated a round trip within a predetermined period, and expected time of arrival of the electric vehicle 200 at this charging facility C is displayed at the electric vehicle 200.

The facility reservation unit 170 of the charging facility guidance device 100 transmits a reservation request to the communication unit 110 for allowing the electric vehicle 200 to be charged at the selected charging facility C on the expected time of arrival of the electric vehicle 200 at the charging facility C. The communication unit 110 transmits the reservation request to the charging facility C (step S116).

The charging facility C receives the reservation request, and makes a reservation for the charger 274 for allowing the electric vehicle 200 to be charged on the expected time of arrival of the electric vehicle 200 (step S117).

The embodiment achieves the following effect. According to the embodiment, the calculation unit 130 is provided. The calculation unit 130 calculates a route for charging in which the charging facility C where the electric vehicle 200 is to be charged is incorporated between a predetermined start point and a predetermined destination, on the basis of vehicle notification information that is the vehicle notification information 164 stored in the storage unit 160, received by the communication unit 110, and including identification information about the electric vehicle 200, positional information about the electric vehicle 200, information indicating the charging state of the electric vehicle 200, and round trip route information about a round trip between the predetermined start point and the predetermined destination, the round trip being made by the electric vehicle 200 equipped with a vehicle-installed communication device.

Thus, if there arises a need to charge the electric vehicle on the way to work, for example, and if a residual charge quantity is such a quantity allowing the electric vehicle to arrive at the nearest charging facility C in a self-propelled manner, the electric vehicle can be given guidance to the charging facility C. In particular, a degree of traveling causing the need for charging can be calculated easily, particularly along a round trip route of a round trip made regularly by the electric vehicle 200, thereby providing appropriate timing for guiding the charging facility C.

The calculation unit 130 avoids a busy charging facility C and incorporates a charging facility C having more room than the busy charging facility C preferentially in the route for charging. This makes it possible to prevent the electric vehicles 200 intended to be charged from concentrating on the predetermined charging facility C.

The vehicle notification information 164 includes information about the state of use of the electric vehicle 200, and the calculation unit 130 calculates the charging facility C to be incorporated in the route for charging on the basis of the vehicle notification information 164. Thus, a traveling distance permitted by a residual charge quantity in the electric vehicle 200 can be calculated more correctly. As a result, it becomes possible to calculate a candidate for the charging facility C to become reliably reachable by traveling in a self-propelled manner using electricity corresponding to the residual charge quantity.

The facility reservation unit 170 is provided. The facility reservation unit 170 communicates with the charging facility C through the communication unit 110 to make a reservation for charging at the charging facility C along the route for charging calculated by the calculation unit 130. This makes it possible to avoid trouble occurring if all the chargers 274 are busy at the time of arrival at the charging facility C, so that the electric vehicle 200 can be charged reliably without delay at the charging facility C.

The present invention is not limited to the embodiment described above but the present invention also includes modifications, improvements, etc. within a range in which the purpose of the present invention is attainable. For example, the configurations of units including a communication unit, an acceptance unit, a calculation unit, and a management unit are not limited to the configurations of the units of the embodiment including the communication unit 110, the acceptance unit 120, the calculation unit 130, and the management unit 140.

### EXPLANATION OF REFERENCE NUMERALS

1 . . . vehicle system
100 . . . charging facility guidance device
110 . . . communication unit
120 . . . acceptance unit
130 . . . calculation unit
140 . . . management unit
150 . . . derivation unit
160 . . . storage unit
161 . . . vehicle information
162 . . . charging facility information
164 . . . vehicle notification information
165 . . . charging facility information
170 . . . facility reservation unit
200-1 to 200-n, 200 . . . electric vehicle

What is claimed is:

1. A charging facility guidance device comprising:
a communication unit that makes communication with a vehicle-installed communication device and with a charging facility;
a calculation unit that calculates a route for charging in which the charging facility where an electric vehicle is to be charged is incorporated between a predetermined start point and a predetermined destination, on the basis of vehicle notification information stored in a storage unit, received by the communication unit, and including identification information about the electric vehicle, positional information about the electric vehicle, information indicating a charging state of the electric vehicle, and round trip route information about a round trip between the predetermined start point and the predetermined destination, the round trip being made by the electric vehicle equipped with the vehicle-installed communication device; and
a management unit that outputs information about the route for charging calculated by the calculation unit.

2. The charging facility guidance device according to claim 1, wherein
the calculation unit avoids incorporating a busy charging facility, and preferentially incorporates a charging facility having more room than the busy charging facility in the route for charging.

3. The charging facility guidance device according to claim 1, wherein the vehicle notification information includes information about a state of use of the electric vehicle, and
the calculation unit calculates the charging facility to be incorporated in the route for charging on the basis of the vehicle notification information.

4. The charging facility guidance device according to claim 1, further comprising a facility reservation unit that communicates with the charging facility through the communication unit to make a reservation for charging at the charging facility along the route for charging calculated by the calculation unit.

5. A charging facility guidance method implemented by a charging facility guidance device comprising a communication unit that makes communication with a vehicle-installed communication device and with a charging facility, the method comprising: calculating a route for charging in which the charging facility where an electric vehicle is to be charged is incorporated between a predetermined start point and a predetermined destination, on the basis of vehicle notification information stored in a storage unit, received by the communication unit, and including identification information about the electric vehicle, positional information about the electric vehicle, information indicating a charging state of the electric vehicle, round trip route information about a round trip between the predetermined start point and the predetermined destination, the round trip being made by the electric vehicle equipped with the vehicle-installed communication device; and outputting information about the route for charging.

6. A non-transitory computer-readable medium storing a program for causing a charging facility guidance device to perform a process, the charging facility guidance device comprising a communication unit that makes communication with a vehicle-installed communication device and with a charging facility, the process comprising: calculating a route for charging in which the charging facility where an electric vehicle is to be charged is incorporated between a predetermined start point and a predetermined destination, on the basis of vehicle notification information stored in a storage unit, received by the communication unit, and including identification information about the electric vehicle, positional information about the electric vehicle, information indicating a charging state of the electric vehicle, and round trip route information about a round trip between the predetermined start point and the predetermined destination, the round trip being made by the electric vehicle equipped with the vehicle-installed communication device; and outputting information about the route for charging.
